(19) United States
(12) Patent Application Publication
(10) Pub. No.: US 2015/0242501 A1
(43) Pub. Date: Aug. 27, 2015

(54) SOCIAL NETWORK ADDRESS BOOK

(71) Applicant: Streetlights LLC, Hingham, MA (US)

(72) Inventor: Benjamin Guild, Hingham, MA (US)

(21) Appl. No.: 14/628,678

(22) Filed: Feb. 23, 2015

Related U.S. Application Data
(60) Provisional application No. 61/942,663, filed on Feb. 21, 2014.

(51) Int. Cl. G06F 17/30; H04L 29/08; G06F 3/0484

(52) U.S. Cl. CPC G06F 17/30861; G06F 3/04842; H04L 67/10

(57) ABSTRACT

A computer system for maintaining a social networking address book is provided. The computer system includes a user interface configured to present a social networking contact list to a user. The social networking contact list includes a plurality of contact entries related to a plurality of existing contacts of the user. The computer system further includes a search engine enabling the user to search the social networking contact list based on a user specified criteria. The computer system may store any desired contact information of personal connections the user may have, including not only conventional phone numbers, mailing addresses, and e-mail addresses, but also social networking user-names and account IDs. A social network created by the social networking address book may be implemented as a decentralized mesh network including a plurality of meshed nodes.

### CROSS REFERENCE TO RELATED APPLICATIONS

This application claims priority to U.S. Patent Application Ser. No. 61/942,663 filed Feb. 21, 2014 which is incorporated by reference in its entirety.

### FIELD OF THE INVENTION

This specification is directed, in general, to address books, and, more particularly, to a social networking address book.

### BACKGROUND OF THE INVENTION

An address book is a book or a database used for storing entries for various contacts, where each contact entry usually consists of a few standard fields (e.g., first name, last name, company name, address, telephone number, e-mail address, fax number, mobile phone number, etc.). Generally, simple address books beyond mere paper form have been incorporated into e-mail software and mobile phones for many years.

Also, an online address book typically enables users to create their own web page (or profile page) which is then indexed by search engines. This in turn enables users to be found by other people via a search of their name and then contacted via their web page containing their personal information. Ability to find people registered with online address books via search engine searches usually varies according to the commonness of the name and the amount of results for the name. Typically users of such systems can synchronize their contact details with other users that they know to ensure that their contact information is kept up to date.

Currently, most people have many different address books: their email accounts, their mobile phone, and the “friends' lists” on their social networks. A network address book allows them to organize and manage all of their address books through a single interface and share their contacts across their different address books. However, network address books available today are limited in functionality, robustness, and overall user-friendliness.

### SUMMARY OF THE INVENTION

The purpose and advantages of the below described illustrated embodiments will be set forth in and apparent from the description that follows. Additional advantages of the illustrated embodiments will be realized and attained by the devices, systems and methods particularly pointed out in the written description and claims hereof, as well as from the appended drawings.

To achieve these and other advantages and in accordance with the purpose of the illustrated embodiments, in one aspect, a computer system for maintaining a social networking address book is provided. The computer system includes a user interface configured to present a social networking contact list to a user. The social networking contact list includes a plurality of contact entries related to a plurality of existing contacts of the user. The computer system further includes a search engine enabling the user to search the social networking contact list based on a user specified criteria. According to embodiments of the present invention, the computer system may store any desired contact information of personal connections the user may have, including not only conventional phone numbers, mailing addresses, and e-mail addresses, but also social networking user-names and account IDs.

### BRIEF DESCRIPTION OF THE DRAWINGS

The embodiments herein may be better understood by referring to the following description in conjunction with the accompanying drawings in which like reference numerals indicate identically or functionally similar elements, of which:

FIG. 1 is a schematic block diagram of an example computing device that may be used with one or more embodiments described herein;

FIGS. 2-4 and 6 illustrate exemplary screen layouts of a social networking address book in accordance with an illustrated embodiment of the present invention;

FIG. 5 is a schematic illustrating flexible group access levels to social networking information according to an embodiment of the present invention; and

FIG. 7 is a flowchart of operational steps of the social networking address book of FIG. 1 directed to adding a new contact to the social networking address book in accordance with illustrative embodiments of the present invention.

### DETAILED DESCRIPTION OF CERTAIN EMBODIMENTS

The present invention is now described more fully with reference to the accompanying drawings, in which illustrated embodiments of the present invention is shown wherein like reference numerals identify like elements. The present invention is not limited in any way to the illustrated embodiments as the illustrated embodiments described below are merely exemplary of the invention, which can be embodied in various forms, as appreciated by one skilled in the art. Therefore, it is to be understood that any structural and functional details disclosed herein are not to be interpreted as limiting, but merely as a basis for the claims and as a representative for teaching one skilled in the art to variously employ the present invention. Furthermore, the terms and phrases used herein are not intended to be limiting but rather to provide an understandable description of the invention.

Unless defined otherwise, all technical and scientific terms used herein have the same meaning as commonly understood by one of ordinary skill in the art to which this invention belongs. Although any methods and materials similar or equivalent to those described herein can also be used in the practice or testing of the present invention, exemplary methods and materials are now described.

It must be noted that as used herein and in the appended claims, the singular forms “a”, “an,” and “the” include plural referents unless the context clearly dictates otherwise. Thus, for example, reference to “a stimulus” includes a plurality of such stimuli and reference to “the signal” includes reference to one or more signals and equivalents thereof known to those skilled in the art, and so forth.

It is to be appreciated the embodiments of this invention as discussed below are preferably a software algorithm, program or code residing on computer useable medium having control logic for enabling execution on a machine having a computer processor. The machine typically includes memory storage configured to provide output from execution of the computer algorithm or program.

As used herein, the term “software” is meant to be synonymous with any code or program that can be in a processor of a host computer, regardless of whether the implementation is in hardware, firmware or as a software computer product available on a disc, a memory storage device, or for download from a remote machine. The embodiments described herein include such software to implement the equations, relationships and algorithms described above.

In the context of a social network service, the term “relationship,” as used herein, refers to a data-sharing relationship established in a given social network, application or service. Some social networks and applications may support several types of data-sharing relationships, where the types and/or quantities of information shared among linked users depends on the type of data-sharing relationships. To simply the following discussion, distinctions between these various types are generally ignored, but it will be appreciated that these distinctions can affect the content of contact information presented to any given user.

One skilled in the art will appreciate further features and advantages of the invention based on the above-described embodiments. Accordingly, the invention is not to be limited by what has been particularly shown and described, except as indicated by the appended claims. The embodiments herein may generally be performed by a user device (e.g., personal computer, mobile computing device, smartphone, wearable device, etc.) in conjunction with one or more servers (data processing, databases, etc.), and various actions described herein may be related specifically to one or both of the user device and/or the servers. In general, the specific type of user device and/or server configuration may be any suitable configuration (e.g., desktop computers, mobile devices, singular servers, server farms, cloud-based computing, etc.), and any reference to particular type of device herein is not meant to limit the scope of the embodiments herein.

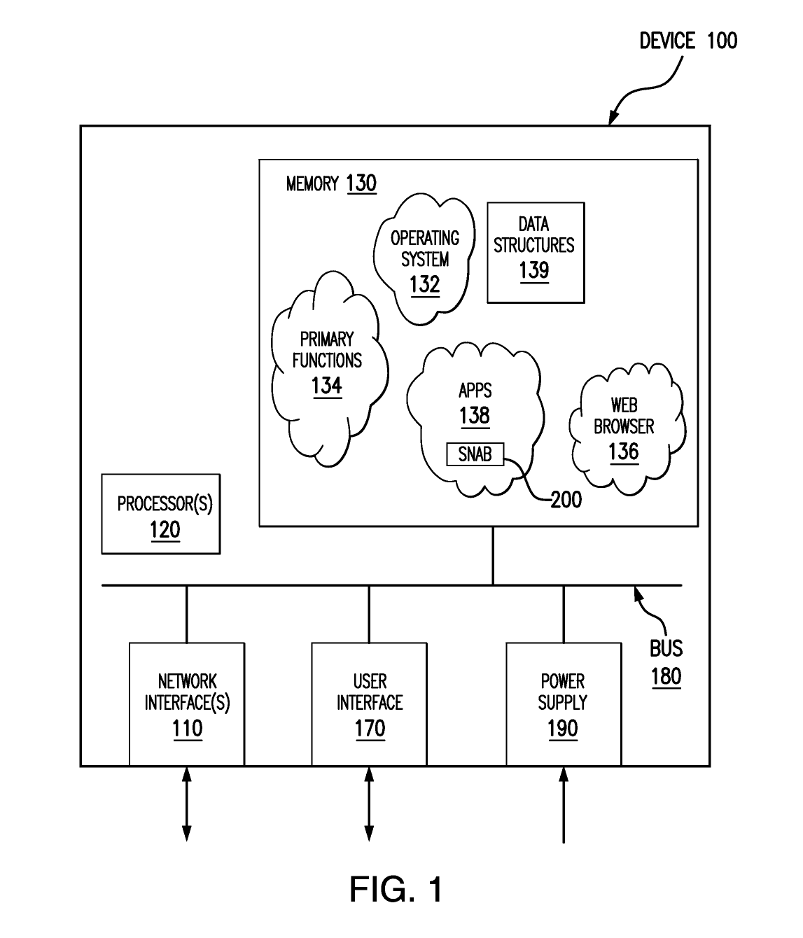

FIG. 1 is a schematic block diagram of an example computing device 100 that may be used with one or more embodiments described herein, e.g., as a user device or a server. The device may comprise at least one network interface 110, at least one processor 120, a memory 130, and user-interface components 170 interconnected by a system bus 180, as well as a power supply 190. Other components may be added to the embodiments herein, and the components listed herein are merely illustrative.

The network interface(s) 110 contain the mechanical, electrical, and signaling circuitry for communicating data over links coupled to a computer network. The memory 130 comprises a plurality of storage devices that are addressable by the processor 120 for storing software programs and data structures associated with the embodiments described herein. The processor 120 may comprise hardware elements or hardware logic adapted to execute the software programs and manipulate the data structures 139. An operating system 132, portions of which are typically resident in memory 130 and executed by the processor, functionally organizes the machine by invoking operations in support of software processes and/or services executing on the machine. These software processes and/or services may (though need not) comprise one or more primary functions 134, a web browser 136, and one or more applications or “apps” 138 (e.g., an option found on many mobile devices). In an embodiment of the present invention, one or more applications or “apps” 138 may comprise, or otherwise may cooperate with a Social Networking Address Book (SNAB) application 200. SNAB 200 may comprise program instructions stored on one or more computer-readable storage devices.

It will be apparent to those skilled in the art that other processor and memory types, including various computer-readable media, may be used to store and execute program instructions pertaining to the techniques described herein. Also, while the description illustrates various processes, it is expressly contemplated that various processes may be embodied as modules configured to operate in accordance with the techniques herein (e.g., according to the functionality of a similar process). Further, while the processes have been shown separately, those skilled in the art will appreciate that processes may be routines or modules within other processes.

Illustratively, certain aspects of the techniques described herein may be performed by hardware, software, and/or firmware, such as in accordance with the various processes and components described herein, which may contain computer executable instructions executed by the processor 120 and/or associated hardware components to perform functions relating to the techniques described herein.

As noted above, network address books available today are limited in functionality, robustness, and overall user-friendliness. The techniques herein, however, provide a social networking address book 200 that allows for a long-term point of contact for people to reach each other. In this manner, the techniques herein provide a “contact backbone” that functions as a social network, allowing users to look up other users by their names, phone numbers, or even by their account names (user IDs, usernames, etc.) in various apps or services. Additionally, the techniques described herein provide notifications to connected users based on recent services subscriptions/updates and based on flexible group access levels to social networking information. For instance, if owners of the social networking address book join a new social network, the social networking address book may automatically notify several of their stored contacts.

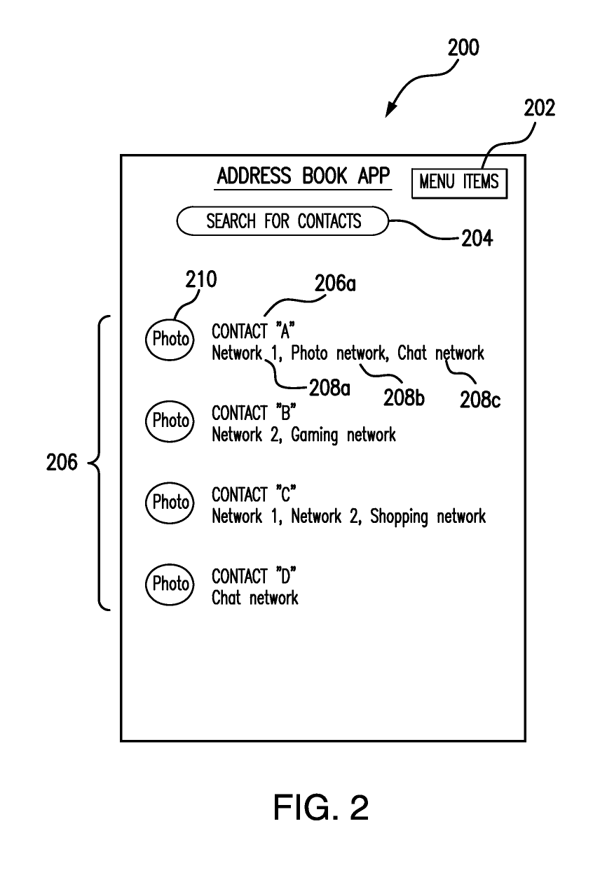

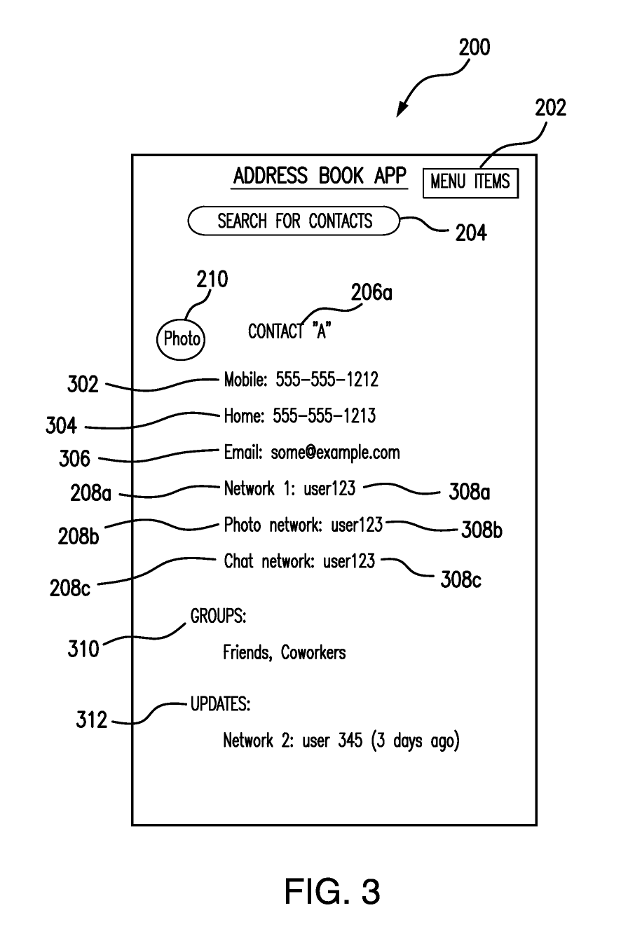

Illustratively, the techniques herein may be presented as an application (“app”), such as social networking address book 200 on a mobile device or other computing device, though they may also be embodied within any type of suitable program (such as web-based, service-based, etc.). FIG. 2 illustrates an example layout of the social networking address book 200, which may contain various features such as menu items 202 (e.g., adding new contacts, editing current contacts, etc.), a search tool 204 for locating current or new contacts, and then a corresponding listing of contacts 206. In one embodiment, each contact may be particularly associated with a set of other applications/apps/services for which that contact's information is known, such as Contact “A” 206a having information for “Network 1” 208a, “Photo network” 208b, and “Chat network” 208c. In addition, as discussed further below, a separate section 312 (shown in FIG. 3) may be specifically dedicated to show any updates to the contact information that may be of interest.

Note that the actual layout need not match that shown in FIG. 2 (or any other example “screen shots” in the figures below), and such images herein are meant only as an example. For instance, the particular apps/services/networks 208 may be specifically listed, or else may be represented by specific color coding, or even by their app logo or icon (e.g., their trademark). Also, the photos 210 selected may be selected by the particular contact (e.g., contact “A” 206a selects his/her own photo), or else may be selected by the owner of the particular address book 200. As a still further alternative, the photos 210 may be automatically populated based on integration with one or more other accounts (e.g., a photo from “network 1” 208a). In general, a goal would be to display useful information within a small screen space, so various implementations are possible (e.g., colored blocks or icons as mentioned above to give a rough outline of networks to which a particular contact is associated).

According to the techniques herein, the account-focused social networking address book 200 focuses on the apps/services 208 that each contact uses (e.g., their usernames, handles, IDs, etc.), thus essentially creating a social network largely focused solely on accounts of other social and communication apps 208, where a layer of identity is established that rests on top of all other services (i.e., as a long term, singular point of contact).

When specifically looking at particular contact's entry, such as shown in FIG. 3, various contact information may be displayed depending upon what services or apps are known. For instance, assume that Contact “A” 206a has a mobile phone number 302, a home phone number 304, and an email address 306. In addition, however, Contact “A” also has user names 308a-c for Network 1 208a (e.g., user123), for a Photo network 208b (e.g., also user123), and a Chat network 208c (e.g., user-123), respectively. As described further below, each contact, such as Contact “A” 206a, may also be assigned to particular groups 310 by owners of the address book 200 to control visibility of owners' contact information available to each contact. Said differently, each user chooses a group for the other user, so there are two group designations per contact relationship. The list of users in the group is not the same from each user's viewpoint, meaning that if Contact “A” 206a is added to the friends group 310 by the owner of the address book 200, this contact might not place the owner of the address book 200 into his own friends group, but might choose to assign him or her to a coworkers group instead. It is noted that in this scenario these users are not aware of each other's group information. Also, any historic updates 312 to the contact's information may also be displayed here as well (and also described below).

Note that in addition to merely listing the information, each component may be individually selectable to provide corresponding functions, such as allowing phone calls, text messages, emails, and so on for conventional information, as well as bringing up a corresponding network app/website corresponding to the contact's username (e.g., “user123” 308a on Network 1 208a). Alternatively, e.g., depending upon configuration, functionality, and/or user preference, the address book 200 owner can simply copy/paste username information for use in the corresponding app/service.

Furthermore, the techniques herein may be configured to implement an application programming interface (API) that allows access for the various social services, apps, software, etc. that a user opts to interact with. In particular, such an API may provide the ability for other apps to have the social networking address book 200 manage contacts for them, or allow people to be found easily using the contacts the address book 200 has on file for that service/app/etc. In one embodiment, the API may be a software component of software networking address book 200 configured to provide contact list and relationship portability between social networking address book 200 and various apps and services in a secure and consistent manner. In one embodiment of the present invention, the provided API may utilize the relationships between users of various applications, services and social networks to control access to apps and features for other users. In particular, the API may include a lookup mechanism so that users may find other users, services may discover each other and applications may discover services used by other services, e.g., service provider interfaces (SPI's).

Note that the techniques herein may also allow address book owner to log in to a particular service/app/etc. using their address book profile. For example, the presence of being logged into the social networking address book 200 alone (i.e., an owner's specific secured address book account) may serve as validation into one or more particular services or apps, and may grant access for the owner to those services or apps. In other words, particular third-party services/apps/etc. may agree to authenticate users based on a trusted relationship with the social networking address book 200. In one example implementation, for instance, if the third-party app's account was verified at one point while the owner was connected to the address book app 200, then that alone may be considered adequate for a type of “cross-authentication” to allow the owner to log into that third-party's app.

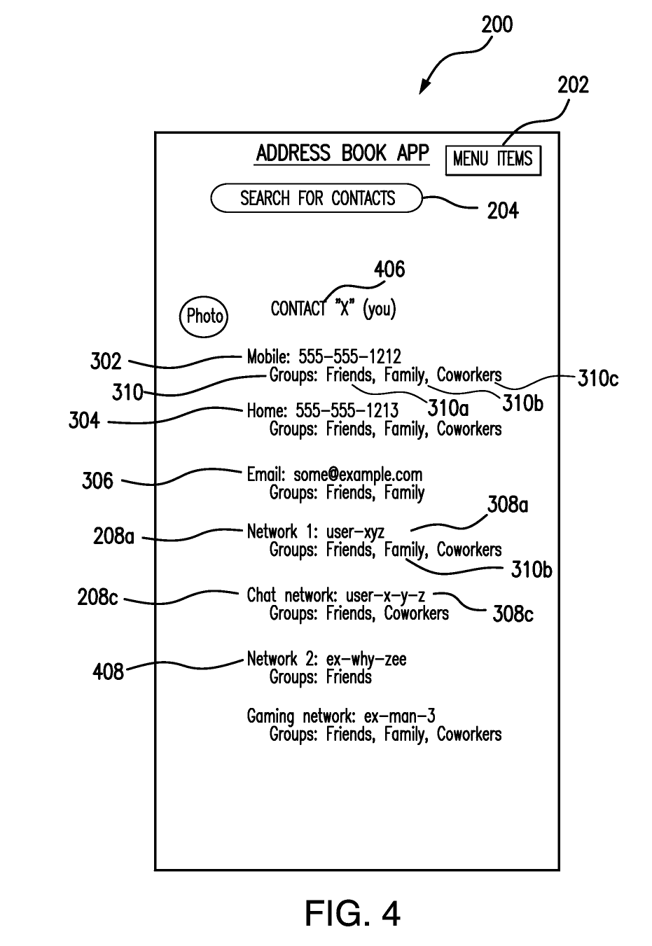

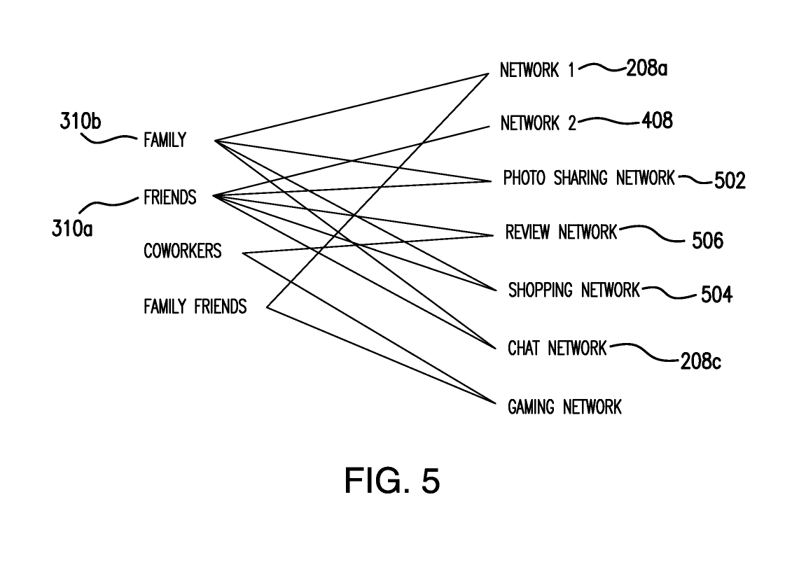

Referring now to FIG. 4, assuming that the owner of the address book 200 is Contact “X” 406, certain information may be manually populated, or else dynamically discovered (described below). Notably, each particular piece of contact information (e.g., mobile phone 302, home phone 304, email address 306, network 1 user ID 308a, etc.) may be assigned to a particular “group” of accessibility 310. In particular, with reference also to FIG. 5, in order to maintain privacy control, users may designate particular groups 310 that may access particular information. For example, members of the “family” group 310b may only see a particular user's network 1 ID 208a, photo sharing network username 502, shopping network username 504, and chat network handle 208c. However, members of the “friends” group 310a may be given access to network 2 408, photo sharing 502, reviews 506, shopping 504, and chat networks 208c. The designation of accessibility may be configured by each particular owner of the address book, and custom-named groups may also be made. By assigning each contact to a particular group or groups 310, the techniques herein may thus limit what each user sees about the owner's contact information. In other words, services/apps can be toggled individually for searchability and optional privacy. For example, people can be found using their handles on the telephone system 302 and 304, email system 306, or other social networks, but a user may wish to not be looked up by their photo network handle 502, and thus they can disable this individually.

Note that though the embodiments herein allow for manual entry of the information (e.g., with optional auto-fill prompting based on other usernames (that is, often people use the same or similar user IDs with different networks)), one or more enhanced embodiments herein may dynamically populate the information according to a number of manners. For example, the address book app 200 may locate apps/services local to the owner's device, and may determine usernames, handles, IDs, etc., associated with those apps/services. In one particular embodiment, the owner may be specifically asked which accounts he/she would like to add to the address book 200. For instance, by using installed apps on the owner's device to populate address book 200 (and suggesting entries for the owner), the owner may be notified if an app is installed but not present in their address book 200 entry, and the information may be auto-filled, or the owner may be prompted to accept the detected username or to fill it in manually.

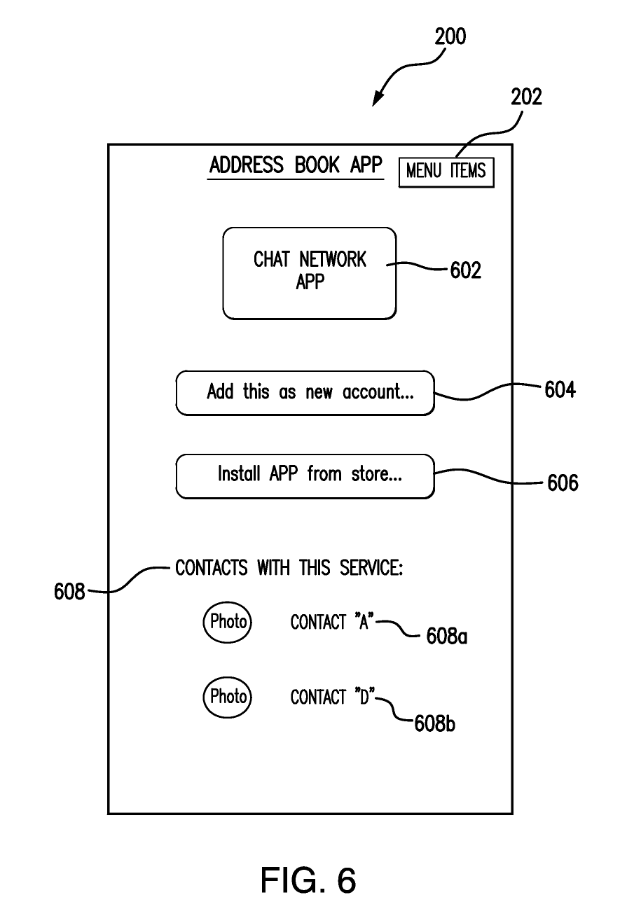

The social networking address book 200 herein may provide a social network in and of itself, which allows users to look up people by any of their other social network connections, and acts as a focal point for discovery of services, new software, and methods for discovery of communication avenues. As an example, assume that by selecting (clicking on) a particular contact, such as Contact “A” 206a the address book owner may discover which (permitted) apps that contact is using, whether or not the owner has that app himself/herself. In this manner, the techniques herein allow for “social discovery” on a contact basis, i.e., discovering social apps/software that is used by particular contacts. In addition, assume now that the owner selects a particular app itself, such as the “chat network app” 602 as shown in FIG. 6. Within this available feature, the owner may be prompted to enter his/her own contact information for this app 604, or if not installed on the device, may be prompted 606 to install it from the corresponding app store. Furthermore, the owner may be presented with a list of known contacts 608 (e.g., contacts “A” 608a and “D” 608b) that have this app 602 installed on their devices, and that have allowed others (i.e., have allowed the owner, in particular) to discover their corresponding user information. Thus, the techniques herein allow for social discovery on a service/app basis as well, i.e., discovering contacts that are using particular social apps/software.

In a preferred embodiment of the present invention, the social network provided by social networking address book 200 may be implemented as a decentralized mesh network comprising a plurality of meshed nodes. As used herein, the term “meshed node” refers to a virtual object that is represented by a communication device (i.e., user's mobile device) which has “meshing capability” meaning that a node has routing functionality and can route traffic to and from other nodes (i.e., virtual objects on user's contacts' devices) with routing functionality. In one embodiment, such virtual objects may comprise one or more applications installed on a communication device. Alternatively, lower level network software may act as a meshed node. According to the preferred embodiment, contact information (such as, but not limited to, telephone numbers, email addresses, and user IDs) is transmitted as digital data between the meshed nodes. Note that apps and services may be utilized as reference pointers in the mesh network.

In accordance with an exemplary embodiment of the invention, an arbitrary number of specialized router nodes (typically a large number) may be interconnected with the plurality of meshed nodes in accordance with various topologies without limiting the invention. The number of router nodes is preferably chosen to obtain a required routing capacity, while the chosen topology employed is a balance between advantages and disadvantages including, but not limited to: cost, complexity, delay, blocking probability, etc. which may be dependent on the routing capacity. In a preferred embodiment, the meshed network may also include one or more performance enhancing proxies; thus allowing more efficient data transfer and significantly better link capacity utilization. In various embodiments, a proxy is a server (a computer system or an application) that acts as an intermediary for requests from meshed nodes seeking resources from other meshed nodes.

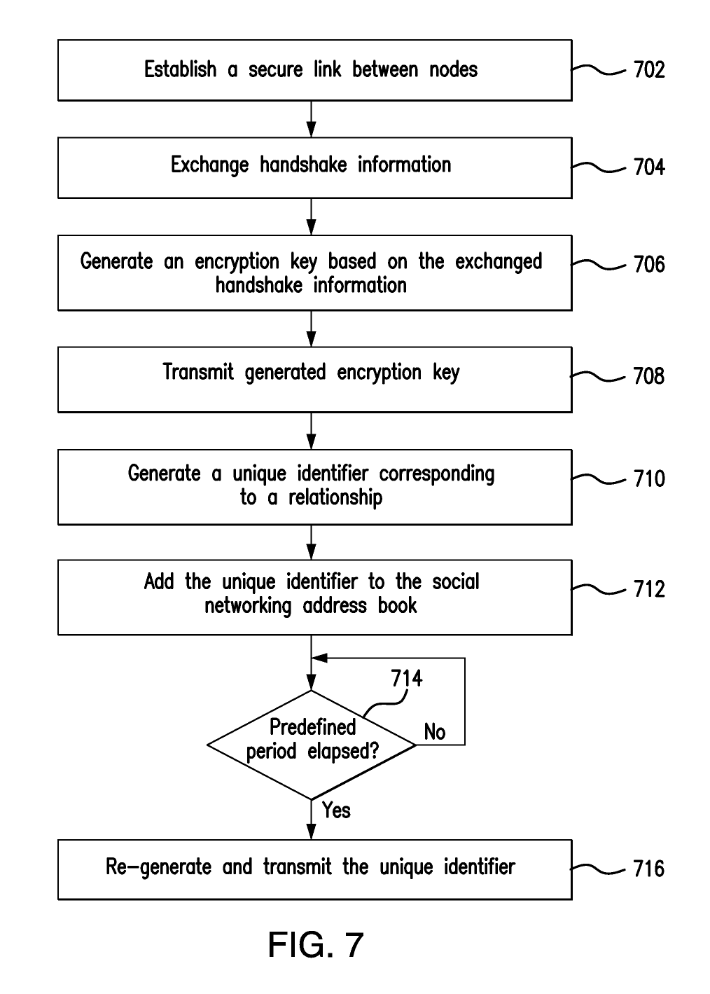

In addition to routing and performance enhancing services, it is contemplated that the meshed network may include other auxiliary services that cannot be offered in a decentralized manner including, without limitation, identity verification, interaction with businesses outside of social networks and the like. That is, disclosed meshed network should have sufficient indicia of the trustworthiness of the participants (users) to encourage the interactions, or at the least, not discourage such interactions. These indicia generally relate to the ability to authenticate the participants to an interaction by a centralized authority. However, such centralized authority would only get access to users' personal data residing on the meshed network that users choose to grant to the centralized authority and only for specific tasks. It is noted that relationships with the centralized authority may be established and/or terminated in a manner similar to that utilized for establishing/terminating relationships between the meshed nodes, as described below with reference to FIG. 7.

In some embodiments the auxiliary services may include specialized archiving nodes corresponding to one or more meshed nodes to ensure uninterrupted network presence of these meshed nodes in the event of device loss or failure, accidental erasure or other accidental loss of data phenomenon. In one embodiment, these archiving nodes may store an encrypted copy of address book entries and/or other relevant data (with an exception of encryption keys) for the corresponding meshed nodes that may be retrieved only in the event of an outage or device failure. Furthermore, if such events occur, the archiving nodes may have an ability to temporarily replace failed meshed nodes with respect to receiving and maintaining internode communications. However, it is contemplated that the meshed nodes requesting protection from the archiving nodes will not share encryption keys, thus precluding the archiving nodes from decrypting the stored and/or exchanged data. In other words, functionality of the specialized archiving nodes is limited to storing and redistributing the encrypted data as instructed or requested by the corresponding meshed nodes.

As noted above, network address books available today are limited in functionality, robustness, and overall user-friendliness. Some common address book implementations, such as the address book available in many existing smartphones, include a search function which permits a user to navigate his or her address book by entering information associated with an entry (i.e., a contact entry's first or last name). However, the ability to locate specific contact information under this model can be tampered with and may compromise the integrity of relationship. The techniques herein, however, provide a social networking address book 200 that enables adding new contacts in a more secure, so called “peer-to-peer” manner.

FIG. 7 is a flowchart of operational steps of the social networking address book 200 of FIG. 1 directed to adding a new contact to the social networking address book 200 in accordance with illustrative embodiments of the present invention. Before turning to description of FIG. 7, it is noted that the flow diagram shown therein is described, by way of example, with reference to components shown in FIGS. 1-6, although these operational steps may be carried out in any system and are not limited to the scenario shown in the aforementioned figures. Additionally, the flow diagram in FIG. 7 shows example in which operational steps are carried out in a particular order, as indicated by the lines connecting the blocks, but the various steps shown in this diagram can be performed in any order, or in any combination or sub-combination. It should be appreciated that in some embodiments some of the steps described below may be combined into a single step or omitted altogether. In some embodiments, one or more additional steps may be included.

Steps described below are based on the physical proximity of the two users and/or their respective devices relative to each other such that short-range radio frequency (RF) communication can be sustained between the two. At step, 702, social networking address book 200 on a first node of the above-described mesh network establishes a secure connection link with a second node. Advantageously, the secure connection link is not an Internet-based communication link. In one embodiment, social networking address book uses short range communication technology such as Near Field Communication (NFC) or Bluetooth® technology. In some of the current phones, the NFC systems are activated automatically as soon as they are placed within a suitable range. For example, two NFC or Bluetooth® enabled nodes may establish a connection and pair themselves automatically. Alternatively, the identification of the other device is achieved by means of NFC, and then a Bluetooth channel is established for the data transfer. This function may well be combined with the present invention if instances of social networking address book 200 or other compatible software apps are installed on both nodes trying to establish a secure communication link.

At step 704, the address book 200 exchanges handshake information with the second node using the established secure channel (link). In various embodiments the exchanged handshake information may include situational and/or geospatial data as a coded pattern. The coded pattern may be a text code, a Quick Response (QR) code or a barcode. The coded pattern, in one example, includes a highly unique biometric template. Additionally, the coded pattern may also include time information corresponding to a time point when the secure communication channel is established. In another example, the handshake information may include synchronized Global Positioning System (GPS) coordinates. Such GPS coordinates may be coordinated by synchronization signals.

At step 706, social networking address book 200 preferably generates a user relationship specific encryption key based on substantially difficult to obtain/reproduce handshake information shared between nodes in step 704. In particular, the generated encryption key is necessary for the networking address book 200 to set up complex security provisions to keep the peer-to-peer connection secure. Moreover, social networking address book 200 may utilize additional hardware and/or software modules to store and maintain such encryption keys. Most encryption techniques utilize a key or keys that translate (i.e., encrypt) the data of a message into an unrecognizable form before transmission. Some encryption techniques utilize a more complex encryption scheme, which is generally more difficult to break than a less complex encryption scheme. However, more complex encryption schemes generally take longer to encrypt and decrypt and, therefore, reduce the throughput for the data session. Thus, choices among encryption techniques can involve tradeoffs between the degree of security and the data processing demands to implement the encryption.

At 708, address book 200 transmits the generated encryption key to the second node via the secure link established at step 702. It should be noted that the encryption keys must be provided to each pair of nodes before the encryption keys may be used to encrypt communications. It is quite important that the social networking address book 200 provides the generated encryption key to the second node in a secure manner via communication link established in step 702, since if a third node learns the pair's encryption keys, the third node will be able to intercept and decrypt communications between the communicating nodes, thereby violating their privacy. Thus, by avoiding the most convenient method for exchanging the confidential encryption keys, such as Internet, social networking address book 200 prevents encrypted traffic from wide area network (WAN)-based and/or Internet-based monitoring.

At 710, social networking address book 200 generates a unique identifier, such as an address corresponding to a relationship between the first and second nodes. It is noted that each node preferably maintains unique network addresses for each relationship. It is further noted that when social networking address book 200 terminates a relationship (for example, when a particular contact is removed from the social networking address book 200) the address generated at 710 is also terminated and that is the only unique identifier utilized for that particular relationship's mesh network communications. This disconnect will not affect other relationships between nodes/apps/users/services/entities on the meshed network. If any particular node has no addressable handles of its own (i.e., no addresses) and assuming active connections with other nodes, it may simply function as a routing node.

In a preferred embodiment, if the first node comprising social networking address book 200 establishes a direct Internet-based or WAN-based connection with any other node, prior to establishing such connection, social networking address book 200 may broadcast an address change request to all meshed nodes with which the social networking address book 200 maintains established relationships. According to embodiment of the present invention, the broadcasted address change request facilitates corresponding address changes in attempt to further shield encrypted mesh network traffic from any WAN-based or Internet-based data monitoring and/or data tampering.

According to an embodiment of the present invention, at 712, social networking address book 200 preferably adds a new contact entry associated with a user of the second node. However, the newly added contact nodes are capable of breaking the relationship by blocking, terminating or changing their addresses thus becoming virtually impossible to find within the mesh network. In other words, nodes remain discoverable only for the topics/services/relationships that they choose to participate in.

As previously indicated, network node addresses are subject to change at any given time even for already established relationships. For example, in one embodiment, social networking address book 200 may be configured to update relationships' network node addresses associated with the newly added contacts, along with other contacts, after an interval of time of the predefined length to further obfuscate a meshed node's communication with other trusted meshed nodes to untrusted sources that may be eavesdropping or attempt to tamper with said data. According to the illustrative embodiment, at 714 address book 200 may periodically determine whether the predefined period of time has expired. In response to determining the configured predefined period of time has expired (decision block 714, yes branch), social address book 200 may re-generate and transmit a new unique address associated with the relationship between the address book owner and a corresponding contact. It is noted that in some embodiments, for security purposes, social networking address book 200 may periodically repeat steps 714, 716 for each relationship associated with each stored contact entry.

Through the nature of social collaboration, the techniques may also be configured to provide for collaborative address card generation and updating. For instance, the techniques herein allow other users to be notified when changes are made to other people's accounts, whether by the owners themselves (e.g., updating a mobile phone number), or in certain configurations by other users (e.g., contact “A” added a home phone number for mutual contact “C”). This may help to correct inconsistencies in local address books, or may help to inform users when their new updates 312 do not match their other contacts' stored information. As such, the techniques herein may allow an address book owner to see other alternatives that are available, suggest changes, etc. Said differently, each user themselves has control over what is shown, but other users' suggestions may also appear as options for an owner's local copy (e.g., if they've previously had access to the same information—i.e., if someone posts a fake number, but an owner has their real number, the owner can retain that real number). Note that deleting a contact's meta information (phone number 302 and 304/email 306) on one owner's address book does not affect others′, but these changes may be reflected when appropriate on others' devices as a suggestion. In one embodiment, such suggestions or updates may be associated with the source of the information, such as being tagged by the “updater” (e.g., the actual contact himself/herself, a mutual contact, or, granted certain permissions, a non-mutual contact).

In addition, in one or more embodiments herein, the address book 200 may provide a time-based historical backup of the particular entries. For instance, there may be times where a mistake is made, or where a user decides to revert back to a previous username for a particular account. For example, due to the collaborative population of the address book as mentioned above, one user may inadvertently input a friend's mobile phone number that they just learned as a home number. If another user sees the “new” home number, they may accept this change, thus updating the friend's home number improperly (that is, the friend's “old” home number is still valid, but it has been replaced by the friend's mobile number). By saving the historical account of previous entries, users can revert changes indefinitely as long as the archive exists. In one embodiment, this archive may exist locally (e.g., a local buffer for the address book app 200), or it may be scattered in an encrypted manner across other untrusted mesh nodes as “packages” or “fragments”, and restorable to the user's devices.

In summary, various embodiments of social networking address book 200 described herein provide a “contact backbone” that functions as a social network, which may be implemented as a mesh network. Additionally, the techniques described herein provide alert notifications to connected users based on recent services subscriptions/updates. Furthermore, new contacts can be added to the address book 200 using one of the short range communication protocols in a manner not involving the Internet/WAN transmissions and not involving any centralized network authority or centralized database. This feature of social networking address book 200 advantageously facilitates secure connections between various nodes of the mesh network and significantly reduces any chance of tampering or monitoring of data (such as user's contact information and/or other personal information) over a long distance. A third-party does not get access to users' personal information because, according to embodiments of the present invention described herein, substantially all communication over the mesh network is encrypted using encryption keys pre-shared during short range communication sessions and because each node maintains a unique network address for each relationship.

While embodiments of the present invention are predominately described with respect to relying on the added security of mesh networks, users of social networking address book 200 may choose to forgo such functionality at a greater convenience for them. At least in some instances, users may choose to create a relationship with a new contact via an Internet-based link or by looking up new contacts using the information they choose to publish in a centralized data repository or index. Although these types of connections would be insecure and possible to be monitored or tampered with, they may provide a faster way to get connected. In some embodiments, users may be able to “secure” those connections later, when meeting in person with that contact, and may subsequently automatically remove or deprecate previously formed insecure relationships. In other words, owners of the social networking address book 200 may begin relationships with a new contact online (i.e., via Internet or other centralized system) and subsequently move those relationships exclusively to the mesh network to obtain better security and anonymity. To facilitate an alternative faster way to connect, in some embodiments, when social networking address book 200 is placed in the insecure operating mode instead of creating an insecure connection the address book app 200 may try to find a mutual contact that was established in a secure manner. In these embodiments, social networking address book 200 may be configured to “tunnel” a newly created relationship through this mutual contact and hence create an intermediate level of security between highly secured mesh network level and insecure Internet-based level. Again, the address book users may be able to further “secure” those connections directly later, when meeting in person with that contact. In a similar manner the address book users may be able to re-establish previously compromised relationships with a centralized authority or other networked organization by visiting a physical location associated with such authority or organization and recreating a more secure relationship in an offline setting.

According to yet another embodiment of the present invention, when two users having insecure relationships with each other meet in person, or are in close physical proximity, social networking address book 200 may be able to detect such occurrence and may be operable to reestablish one or more relationships between the users in a more secure context of decentralized mesh network by utilizing operational steps described above in conjunction with FIG. 7. In addition, when a user of social networking address book 200 meets one or more contacts in person, they may voluntarily choose to “refresh” their encryption keys and addresses associated with those contacts' relationships (even the ones previously established in a secure manner) to further improve security of such connections.

The foregoing description has been directed to specific embodiments. It will be apparent, however, that other variations and modifications may be made to the described embodiments, with the attainment of some or all of their advantages. For instance, it is expressly contemplated that certain components and/or elements described herein can be implemented as software being stored on a tangible (non-transitory) computer-readable medium (e.g., disks/CDs/RAM/EEPROM/etc.) having program instructions executing on a computer, hardware, firmware, or a combination thereof. Accordingly this description is to be taken only by way of example and not to otherwise limit the scope of the embodiments herein. Therefore, it is the object of the appended claims to cover all such variations and modifications as come within the true spirit and scope of the embodiments herein.

What is claimed is:

1. A method for adding a new contact to a social networking address book, the method comprising:
establishing, by a processor of a first node, a secure connection link with a processor of a second node, wherein the secure connection link is not an Internet-based communication link;
exchanging, by the first and second nodes, handshake information using the secure connection link;
generating, by the processor of the first node, an encryption key based on the exchanged handshake information;
generating, by the processor of the first node, a first unique identifier corresponding to a relationship between the first node and the second node based on the generated encryption key; and
adding the first unique identifier as a new contact information entry to the social networking address book.

2. The method of claim 1, wherein the secure connection link comprises one of: a Bluetooth connection, a near field communication link, and the like.

3. The method of claim 1, wherein the handshake information comprises at least one of the following: a text code, a bar code, a Quick Response (QR) code, a biometric template, time information corresponding to a time point when the secure connection link is established, synchronized Global Positioning System (GPS) coordinates of the first node and the second node.

4. The method of claim 1, further comprising transmitting the generated encryption key by the first node to the second node using the secure connection link.

5. The method of claim 1, further comprising:
removing, by the processor of the first node, the first unique identifier from the social networking address book after a predefined period of time;
generating, by the processor of the first node, a second unique identifier corresponding to the relationship between the first node and the second node based on the generated encryption key; and
transmitting, by the processor of the first node, a request to update a unique identifier corresponding to the relationship between the first node and the second node, wherein the request includes the generated second unique identifier.

6. A computer system for maintaining a social networking address book, the computer system comprising one or more processors, one or more computer-readable storage devices, and a plurality of program instructions stored on at least one of the one or more storage devices for execution by at least one of the one or more processors, the plurality of program instructions comprising:
program instructions to store a social networking contact list, the social networking contact list containing a plurality of contact entries related to a plurality of existing contacts of a user;
program instructions to render a user interface, wherein the user interface is configured to present the social networking contact list to the user; and
program instructions to search the social networking contact list based on a user specified criteria.

7. The system of claim 6, wherein each of the plurality of contact entries corresponding to the plurality of the existing contacts includes information related to a plurality of services and applications utilized by the corresponding contact.

8. The system of claim 6, wherein the program instructions to render a user interface comprise program instructions to enable the user to designate a group of the plurality of contact entries as having accessibility to a designated subset of user's contact information.

9. The system of claim 6, wherein the program instructions to search the social networking contact list comprise program instructions to search for authentication information related to contact's application or service.

10. The system of claim 7, further comprising program instructions to provide an Application Programming Interface (API) configured to integrate the social networking address book with the plurality of services and applications.

11. The system of claim 6, further comprising program instructions to authenticate the user prior to presenting the social networking contact list to the user and program instructions to grant the user access to one or more of the plurality of applications or services associated with user's entry in the social networking address book.

12. The system of claim 7, further comprising programming instructions to determine whether the user utilizes one or more of the plurality of services and applications utilized by the corresponding contact.

13. The system of claim 6, further comprising program instructions to perform a time-based historical backup of the social networking address book.

14. The system of claim 7, wherein each of the plurality of contact entries comprises one or more phone numbers, one or more email addresses, one or more images of the corresponding contact and authentication information related to the plurality of services and applications utilized by the corresponding contact.

15. The system of claim 14, wherein the program instructions to render a user interface further comprise program instructions enabling the user to select the image to be associated with user's entry in the social networking address book.

16. A computer program product for maintaining a social networking address book, the computer program product comprising:
one or more computer-readable storage devices and a plurality of program instructions stored on at least one of the one or more computer-readable storage devices, the plurality of program instructions comprising:
program instructions to store a social networking contact list, the social networking contact list containing a plurality of contact entries related to a plurality of existing contacts of a user;
program instructions to render a user interface, wherein the user interface is configured to present the social networking contact list to the user; and
program instructions to search the social networking contact list based on a user specified criteria.

17. The computer program product of claim 16, wherein each of the plurality of contact entries corresponding to the plurality of the existing contacts includes information related to a plurality of services and applications utilized by the corresponding contact.

18. The computer program product of claim 16, wherein the program instructions to render a user interface comprise program instructions to enable the user to designate a group of the plurality of contact entries as having accessibility to a designated subset of user's contact information.

19. The computer program product of claim 16, wherein the program instructions to search the social networking contact list comprise program instructions to search for authentication information related to contact's application or service.

20. The computer program product of claim 17, further comprising program instructions to provide an Application Programming Interface (API) configured to integrate the social networking address book with the plurality of services and applications.
